(19) United States
(12) Patent Application Publication
(10) Pub. No.: US 2005/0216707 A1
(43) Pub. Date: Sep. 29, 2005

(54) Configurable microprocessor architecture incorporating direct execution unit connectivity

(76) Inventor: Richard Michael Taylor, Dalkeith (GB)

Correspondence Address: ALFRED D. LOBO, 933 THE LEADER BLDG, 526 SUPERIOR AVE., E., CLEVELAND, OH, 44114, US

(21) Appl. No.: 10/519,037

(22) PCT Filed: Jun. 30, 2003
(86) PCT No.: PCT/GB03/02774

§ 371 Date: Dec. 22, 2004

(30) Foreign Application Priority Data
Jun. 28, 2002 (GB) 0215028.2

(51) Int. Cl. G06F 9/30

(52) U.S. Cl. 712/218

(57) ABSTRACT

An architecture for a highly configurable and scalable microprocessor architecture designed for exploiting instruction level parallelism in specific application code. It consists of a number of execution units with configurable connectivity between them and a means to copy data through execution units under software control.

### TECHNICAL FIELD

The present invention is in the field of digital computing systems. In particular, it relates to the internal architecture of a configurable microprocessor system.

### BACKGROUND ART

Much of modern microprocessor design is focused on achieving higher levels of parallelism in instruction execution. This increases the throughput of the processor at a given dock frequency. Moreover, in the context of embedded systems where power consumption is often a significant consideration, it allows the same level of performance at a lower dock frequency and thus saves power. A key problem in achieving high levels of parallelism is the design of a centralized register file.

As the level of parallelism in the instruction stream increases so does the number of access ports required to a centralized register file. They are required to provide operands to and write back results from all the active functional units. The complexity of the register file grows at approximately N³ where N is the number of access ports. The register file soon becomes the bottleneck in the design and starts to have a strongly detrimental affect on the maximum dock speed.

This scalability issue is further hampered by the need to provide an extensive network of feed-forward buses between the various access ports. Register read and write operations are typically performed in different stages of the execution pipeline. However, in order to achieve high code performance it is a requirement that an instruction can pass its results onto an immediately following instruction. Such an instruction is executed just one dock cycle later (presuming the instruction only takes one dock cycle to perform). This requires that the register file can detect reads and writes being performed on the same dock cycle to the same register and provide special forwarding buses to directly transfer the data to the reading unit without having to write to the register file first. Given that the number of access ports and the requirement that every write port has to be compared against every read port, this creates a very challenging circuit design. Moreover, it is within the critical path of the processor pipeline and has a direct impact on maximum dock frequency for whole processor.

Some Very Long Instruction Word (VLIW) architectures have adopted a clustered approach to help alleviate this issue. In this model the functional units are partitioned into clusters, each having a private register file. Communication between dusters requires one additional dock cycle of latency. Thus performance suffers if there is significant communication between clusters. Code generation for such machines seeks to minimise the number of data transfers between clusters.

Another approach is that undertaken within the field of Transport Triggered Architectures (TTA). Code for TTAs controls transports rather than operations. That is, the instruction set specifies how data items are moved around the machine to different functional units. It is transport rather than operation centric in nature. By explicitly managing the transport of data between functional units and the register file, a TTA is able to reduce the total number of access ports required to the register file. Moreover, a TTA explicitly schedules the transport of data over feed-forward buses and thus avoids the need for complex register number comparison logic.

### SUMMARY OF INVENTION

The disclosure describes a processor microarchitecture targeted at use in embedded systems where there is significant repetition of the code sequences that are executed by the processor. The microarchitecture is designed to be highly configurable in order to support an automated processor generation method. Such a method analyses application software and automatically architects a processor architecture with functional unit and connectivity resources that reflect the requirements of the key code sequences within the application software. The disclosure provides a highly configurable and scalable microarchitecture to support such a design trajectory.

A two-tier register file structure is used. There is a main register file but it has a very limited number of access ports. The code generator seeks to minimise the number of register file accesses by passing data values directly between functional units and intermediate holding registers without passing them through the register file. Moreover, reads and writes to the register file are explicitly generated by the code generator like any other operation. The register file is treated like any other functional unit in the processor and has no special status.

Each functional unit has output registers for holding its results. Operands for functional units are obtained via multiplexers that select results from a number of different result registers. The execution words include the selection settings for these multiplexers on each dock cycle. Thus rather than specifying a register number, where an operand is to be read or written, it specifies the bus on which a particular data item is available. The code generator is aware of the structure of the buses in the processor and controls them alongside the functional units themselves. The majority of data values are passed from functional unit to functional unit without even passing through the register file.

If every functional unit could read from any result register then the problems of the centralized register file would return, due to the level of connectivity to the multiplexers. Connectivity in the architecture is generally minimized and focused on the connections that provide the most impact on overall performance. Thus certain functional units may have to communicate data that are not directly connected. To support this certain functional units are able to copy data from their input operands to their outputs. That way data can be transported around the functional units as required using copies through functional units.

The microarchitecture also includes a branch mechanism that allows the actual execution of a branch to be decoupled from the point of branch issue, using relatively simple hardware mechanisms. It allows the microarchitecture to choose from one of a number of issued branches to actually execute. This can be used to reduce the number of branches performed and the disruption caused to the execution pipeline by the execution of such branches.

### BRIEF DESCRIPTION OF DRAWINGS

FIG. 1 illustrates the copying of data through a functional unit.

FIG. 2 shows the general architecture of a functional unit and its connectivity to other blocks within the architecture.

FIG. 3 shows an example logical layout of functional units.

FIG. 4 illustrates how the execution word is used to control the state of operand multiplexers in the architecture in order to control data flow in the system.

FIG. 5 shows the decomposition of the Next Region Address into its constituent components.

FIG. 6 provides an illustration of how execution words are formed into regions that have particular control flow relationships.

FIG. 7 shows an overview of the internal architecture of the branch control unit.

FIG. 8 illustrates how the execution word can be broken into a number of different groups, each of which can be used for control of a particular functional unit.

FIG. 9 provides an overview of the components within a functional unit.

FIG. 10 also provides an overview of the components within a functional unit and also provides information about the data and control connectivity between the components.

FIG. 11 provides an overview of the internal architecture of a conditional functional unit controller.

FIG. 12 provides an overview of the internal architecture of an unconditional functional unit controller.

FIG. 13 provides an overview of the internal architecture of an operand selector.

FIG. 14 provides an overview of the internal architecture of the delay pipeline.

FIG. 15 provides an overview of the internal architecture of the output bank unit.

FIG. 16 illustrates the data flow between various pipeline stages of due to interactions between functional units of differing latencies.

FIG. 17 illustrates a timeline show data flow between functional units in the data path of an example processor.

FIG. 18 illustrates a timeline of the events that occur at the end of a region execution that allow execution of a new region to be initiated.

FIG. 19 provides a state transition diagram of the states within the branch unit.

### DESCRIPTION OF PRESENTLY PREFERRED EMBODIMENT

This disclosure describes the underlying microarchitecture of the preferred embodiment. It shows how instructions are fetched, decoded and directed towards the appropriate execution unit. It also shows how the branch control mechanisms are implemented.

The philosophy of the microarchitecture is significantly different from contemporary RISC and VLIW architectures. These architectures tend to be very operation centric in their nature. The instruction set consists of several different operations that are executed on one of a number of execution units. Each of these instructions reads operands from the central register file and writes all results back to the same central register file. The instruction format consists of the specification of the operation and the register file location of the operands and result. The programmer does not specify the buses that are used to transport data to and from the execution units. Indeed, these buses are architecturally invisible at the instruction level. In a highly pipelined architecture the bus structures are actually very complex as multiple bypass paths also have to be present to allow the register file to be pipelined. The register file itself is a central bottleneck of the architecture that needs to be connected via buses to all execution units in the system. To support multiple parallel operations it also needs to support many simultaneous read and write access ports.

As feature sizes of modern VLSI technology are reduced, the distance that can be spanned over the chip in a single cycle is rapidly reducing. Wire propagation delays are starting to dominate over gate delays. The buses that connect systems together within a processor are starting to become much more important to the overall performance of the system. This is not sufficiently reflected in the architectural design of processors.

The preferred embodiment is a highly communication orientated architecture. It is the position of the bits in the execution word that specifies which operation should be performed. The bits themselves explicitly specify which buses should be used to transport operand data into an execution unit. All data buses in the architecture are under explicit software control. There are no hidden, bypass or feed-forward buses.

Although the architecture does have a central register file it is treated like any other implicit functional unit. All accesses to the register file have to be explicitly scheduled as separate operations. Since the register file acts like any other functional unit its bandwidth is limited. The code is constructed so that the majority of data values are communicated directly between functional units without being written to the register file.

Given the requirement to make the architecture highly scalable, communication of all data through a centralised register file is not a viable architectural option. Whenever a functional unit generates a result it is held in an output register until explicitly overwritten by a subsequent operation issued to the unit. During this time the functional unit to which the result is connected may read it.

A single functional unit may have multiple output registers. Each of these is connected to different functional units or functional unit operands. The output registers that are overwritten by a new result from a functional unit are programmed as part of the execution word. This allows the functional unit to be utilised even if the value from a particular output register has yet to be used. It would be highly inefficient to leave an entire functional unit idle in order to preserve the result latched on its output. In effect each functional unit has a small, dedicated, output register file associated with it to preserve its results.

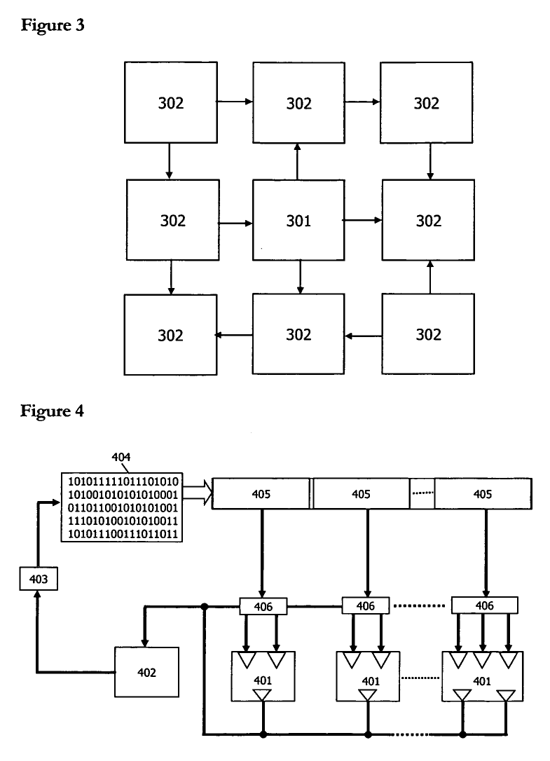

An example functional unit array is given in FIG. 3. The register file unit 301 is placed at the centre with other functional units 302 placed as required by the application of the processor architecture. Given the connectivity limitations of the functional unit array, not every unit is connected to every other. Thus in some circumstances a data item may be generated by one unit and needs to be transported to another unit with which there is no direct connection. The placement of the units and the connections between them is specifically designed to minimise the number of occasions on which this occurs. The interconnection network is optimised for the data flow that is characteristic of the required application code. The microarchitecture also includes an instruction cache. It stores a subset of the code used to control the operation of the functional units. A new execution word is fetched on each clock cycle and distributed throughout the functional unit array in order to orchestrate the issuing of operations and the steering of data between functional units.

To allow the transport of such data items, any functional unit may act as a repeater. That is it may select one of its operands and simply copy it to its output without any modification of the data. Thus a particular value may be transmitted to any operand of a particular unit by using functional units in repeater mode. A number of individual “hops” between functional units may have to be made to reach a particular destination. Moreover, there may be several routes to the same destination. The code generator selects the most appropriate route depending upon other operations being performed in parallel.

There are underlying rules that govern how functional units can be connected together. Local connections are primarily driven by the predominate data flows between the units. Higher level rules ensure that all operands and results in the functional unit array are fully reachable. That is, any result can reach any operand via a path through the array using units as repeaters. These rules ensure that any code sequence involving the functional units can be generated. The performance of the code generated will obviously depend on how well the data flows match the general characteristics of the application. Code that represents a poor match will require much more use of repeating through the array.

Region Based Execution

In the preferred embodiment all execution is performed within blocks of code called regions. This simplifies the implementation of both the instruction scheduling and the control mechanisms in the hardware.

A region is a block of code that only has a single entry point but potentially many exit points. The analysis performed by the code generation tools is able to form groups of basic blocks into regions. Regions are often used as the basic arena in which global scheduling optimisations are performed. Global scheduling refers to the movement of instructions across branches as well as within individual basic blocks.

In the architecture, regions are always executed fully. If the region contains a number of internal branches to basic blocks outside of the region then they are not resolved until the end of the region reached. The compiler constructs the regions from basic blocks so that they contain the most likely execution paths through the basic blocks. A region is able to perform a multi-way branch to select one of a number of different successor regions.

FIG. 6 illustrates an example set of regions 601 and the relationships between them. It shows the execution of the individual basic blocks 603, 604 and 605 within each region. The regions themselves are composed of individual execution words 602. The set of control edges 606 from each region shows the possible successor for each region.

Execution Word Representation

The preferred embodiment uses a Very Large Instruction Word (VLIW) format. This enables many parallel operations to be initiated on a single clock cycle, enabling significant parallelism. The actual width is configurable. Shorter widths tend to be more efficient in terms of code density but poorer in extracting parallelism from the application.

The instruction format is not fixed either and is dependent upon the execution units the user defines for a particular processor. Unlike many contemporary VLIW architectures, the architecture uses a flat decode structure. This means that a particular execution unit is always controlled from a specific group of bits in the execution word. This makes the instruction decoding for the architecture very straightforward. Other VLIWs tend to bundle a number of independent operations into a single instruction word. They still require quite complex decode logic to direct different operations to the appropriate execution units.

FIG. 4 illustrates the basic instruction decode and control paths of the processor. The instruction memory 404 holds the representation of the operations in the customized format for the processor. A new execution word is fetched on each clock cycle. Each block of bits 405 in the execution word is used for controlling a particular execution unit 401.

The bits in the execution word are used to control multiplexers 406 that direct data from the interconnection network to the operand inputs of the execution unit. Results from the execution units are routed back to the interconnection network to be used by subsequent operations.

A branch control unit 402 allows the architecture to execute new blocks of code by loading a new value in the PC (Program Counter) 403. If a branch is not executed then the PC is just incremented on each cycle to execute code sequentially from the instruction memory.

The code is stored in 32 bit width words in main memory and transferred to a wider instruction cache prior to actual execution. The instruction cache has a certain capacity to allow particular code loops to remain cached without continuous access to main memory required. The wider instruction buffer can be configured in size to support power consumption and area goals.

All bits within the execution word have positional context. There is a direct relationship between particular bits and the functional units that they control. This greatly simplifies the execution word decoding task. The appropriate bits for a particular functional unit are simply routed from the execution unit word as required.

The basic structure of the execution word is illustrated in FIG. 8. The execution word 801 is subdivided into a number of groups 802. Each group 803 controls one or more functional units 804. The number of bits required to control a given functional unit is related to the number of selectable sources for the unit's operands and the number of output registers for its results. As the number is increased the number of bits required to uniquely specify them grows.

If a group controls more than one functional unit then bits within the group may be shared. A selection code is then used to indicate which particular functional unit is selected on each dock cycle. This overlay mechanism allows direct trade-off between code density and parallelism (i.e. performance) independently of the functional unit selections. A narrow execution word forces more functional units to share groups. If more than one of those units could be utilised on a particular cycle then performance may be lost as only one may be selected. However, a narrow execution word increases the chances that all groups are usefully employed on each dock cycle and thus code density is improved. If a wider execution word is employed then greater parallelism is possible (as there is less sharing within each group) but groups are more likely to go unused on any particular dock cycle.

The whole of the execution word is used for controlling functional units apart from one bit. This is the End Region Flag (ERF) and is used to indicate that the last execution word in a region has been reached.

Functional Units

The microarchitecture includes a configurable number of functional units. Each of those functional units performs a particular operation upon a number of data operands to produce a number of results. The functional units are pipelined and units with different latencies may be freely mixed in the microarchitecture. The functional unit types and connectivity may be configured as required. In the preferred embodiment this configuration is determined by an automated analysis that finds the functional unit mix and connectivity that is best matched to the requirements of the application code that the processor is to execute.

The internal architecture of functional unit is in FIG. 2. The central core of a functional unit 203 is the execution unit itself 201. It performs the particular operation for the unit. These blocks allow the functional unit to connect to other units and to allow the unit to be controlled from the execution word 205.

Functional units are placed within a virtual array arrangement. Individual functional units can only communicate with near neighbours within this array. This spatial layout prevents the architectural synthesis generating excessively long interconnects between units that would significantly impact dock speed.

Fields within the execution word control the operand multiplexers 206. These are responsible for selecting the correct operands 202 to present to the execution unit. In some circumstances the operand may be fixed to a certain bus, removing the requirement for a multiplexer. The number of selectable sources and the choice of particular source buses are completely configurable. The control input 207 determines the type of operation to be performed.

All results from an execution unit are held in independent output registers 204. These drive data on buses connected to other functional units. Data is passed from one functional unit to another in this manner. The output register holds the same data until a new operation is performed on the functional unit that explicitly overwrites the register.

The functional units represent the building blocks of the processor. The selection of functional units represents the basic configurability of the architecture. Functional units may be selected as required for a particular application domain. The connections between the functional units form them into constituent components of a fully programmable processor. Individual functional units may be replicated as required in order to exploit parallelism in the software targeted at the processor.

Embedded within the functional unit is the execution unit. This is the block that actually performs the required operations. The execution unit is surrounded by additional logic that allows the execution unit to be controlled by software as part of a processor and to communicate with other functional units. All inputs to the execution unit are selected from a number a number of data buses. These buses communicate data between the individual units within the processor. Outputs from the execution unit are latched and then driven over a data bus for use by another functional unit. Each functional unit is also embedded with some control logic to allow the unit to be controlled from the execution word of the processor. A method operand is extracted that selects which particular operation the execution unit should perform.

A detailed architecture overview of a functional unit is shown in FIG. 10. This shows the internal connectivity between the constituent blocks. Both data signals 1012 and control signals 1013 are shown. The diagram shows an execution unit with two operand ports and one output port. However, the number of both input and output ports is completely configurable.

The constituent blocks are as follows:

Execution Unit: The execution unit 1001 receives operand data values from the operands 1014. These operands are fed by operand selectors 1002. In general a particular operand will have multiple potential data sources 1003. However, if only one data source is required then an operand port may be directly connected to the external data bus, avoiding the need for an operand selector. A method selection 1015 is obtained from the controller unit. This is extracted directly from the execution word 1004 but is delayed by one dock cycle by the controller so its presentation is in synchronization with the associated operands. The select flag 1016 is asserted if the execution unit has been selected to perform a new operation during the dock cycle. If the flag is false then the method and operand inputs are undefined. The execution unit generates a number of results 1017.

Controller: The controller 1007 reads the opcode portion of the execution word and compares the code against the fixed selection code 1008 for the unit. If there is a match then the unit is being selected. The predicate mask 1005 shows the status of various conditions. The predicate condition associated with the operation belongs is specified as part of the execution word. An operation is only performed if that predicate is true. Finally, the wait flag 1006 is used to indicate a pipeline stall and is used to prevent further operations being issued to the unit.

Operand Selector(s): An operand selector 1002 is a simply a multiplexer for selecting one of a number of data inputs from data buses. A portion of bits from the execution word is used to specify the bus to be selected. These bits are registered so that they are delayed by one clock cycle. This causes the data steering to be performed a cycle later than the execution word distribution, as is required.

Delay Pipeline: The delay pipeline 1010 simply delays the output register mask by a number of dock cycles. The delay period is one less than the latency of the execution unit. Thus if the execution unit has a latency of one then no delay pipeline is required. This allows the correct output registers to be updated when the results from an operation are available.

Output Registers: The number of output registers 1009 is equal to the number of output connections 1011 from the unit. As the execution unit generates results and this is registered in one or more of the output registers. An output register mask is included in the execution word and specifies which registers should be latched for any given operation. New data from the execution is only registered if it is producing a valid output during that cycle. Data remains in the output register until explicitly overwritten by subsequent operations performed on a functional unit.

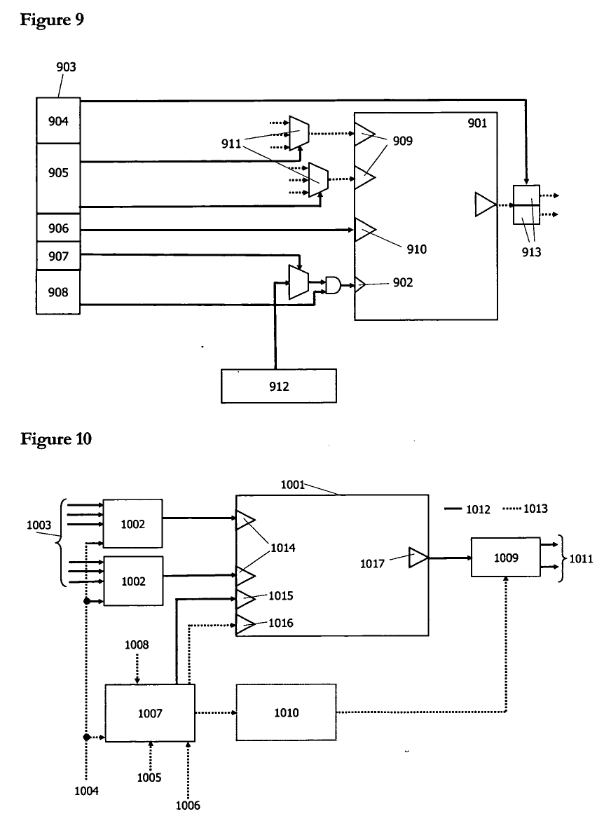

FIG. 9 shows greater detail of the control plane for a functional unit. The area 903 shows the bits within the execution word that are used to control the functional unit. This is composed of a number of different sections for describing different aspects of the operation to be performed by the functional unit. This field is formed from a subset of bits from an overall execution word used to control all of the functional units within the architecture.

The sub-field 904 controls which of the output registers should be updated with a result. The sub-field 905 is used to control the operand multiplexers 911 to select the correct source of data for an operation. This data is fed to the execution unit via the operand inputs 909. The sub-field 906 provides the method that should be performed by the execution unit and is fed to the unit via the input 910.

The optional sub-field 907 provides the number of a predicate flag which controls the execution. This is used to select the corresponding status bit from a predicate status mask 912 via the multiplexer. This is a global state accessible to all functional units that indicates dynamically which instructions should be completed. This is used to condition the functional unit select so that if a particular instruction is disabled then the functional unit operation is not performed. Certain functional units may be executed unconditionally and do not require such a field.

The opcode bits 908 are used to select the particular functional unit. If the opcode does not have the required value then all of the other bits are considered to be undefined and the functional unit performs no operation.

Controller Unit

The controller glue unit is responsible for generating the unit select signal, the result selector and the output register mask. The unit select signal is asserted if a new operation is being initiated on the execution unit during the cycle. The output register mask is used to control the registering of new data in the output registers of the functional unit.

There are two distinct types of controller unit depending upon whether execution is conditional on a particular predicate. If an execution unit has no side effects then it can be executed unconditionally as a speculative use of the unit will not have any permanent side effects. Units that result in side effects (such as any unit with internal state such as register file or memory unit) must always be executed conditionally. Unconditional units can have a more compact representation than conditional units as no predicate number needs to be specified as part of the execution word.

Conditional Controller

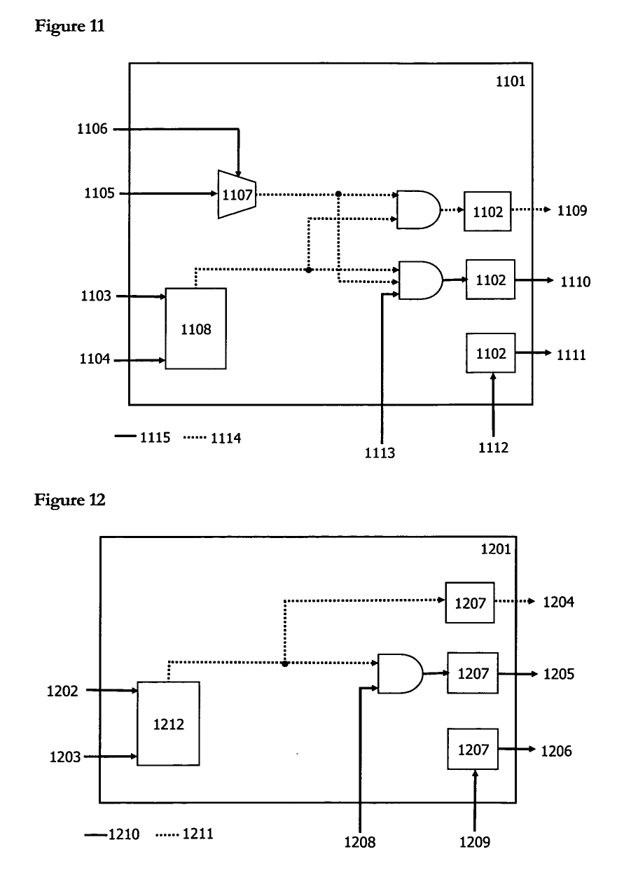

FIG. 11 shows the internal architecture and connectivity for a conditional controller glue unit. The figure shows both data signals 1115 and control signals 1114. A conditional controller 1101 is used when the execution unit has internal state so that certain methods cannot be executed speculatively. A predicate selector field 1106 is used to select 1107 the appropriate bit from a predicate status mask 1105. This is used to gate both the unit select 1109 and the output register mask 1110. An incoming opcode 1103 is compared against a fixed selection code 1104 using the comparator 1108. The output of this is also used to gate the unit select 1109 and output register mask 1110.

The register 1102 is used to delay the unit select 1109 so that it is valid during the execute cycle of the execution unit. Another register is used to hold the conditioned form of the output register mask 1113. This ensures that the output registers are not updated if a unit is not selected during a cycle. Finally the method 1112 is simply delayed by one clock cycle to generate the method 1111 that is in synchronization with the other signals.

Unconditional Controller

FIG. 12 shows the internal architecture of an unconditional controller glue unit. Both data signals 1210 and control signals 1211 are shown. An unconditional controller 1201 is used when the execution unit has no internal state so all methods can be performed speculatively. The opcode 1202 is compared against the fixed selection code 1203 using the comparator 1212. This generates a signal that conditions the unit select 1204 and output register mask 1205. The unit select is registered 1207 to generate a unit select during the execute cycle of the execution unit. The output register mask 1208 is conditioned and registered to produce the value 1205 in the correct clock cycle. The method field 1209 is simply registered to generate the method 1206 in the correct execution cycle.

Operand Selector Unit

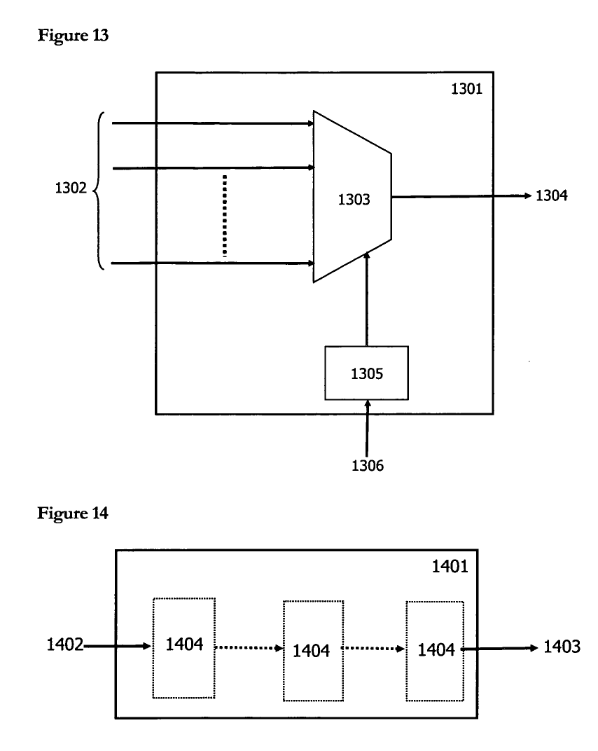

FIG. 13 shows the basic structure of an operand selector unit. An operand selector 1301 is primarily composed of a multiplexer 1303 that directs the contents of a particular data bus 1302 to the output operand 1304. The output operand is then fed to the input of an execution unit. The switching of the multiplexer is performed during the first execution cycle of the execution unit. The multiplexer is controlled directly by specific bits in the execution word 1306. These are distributed during the decode cycle and are held in the register 1305 until the first execution cycle.

Delay Pipeline Unit

The delay pipeline simply delays the Output Register Mask bits so that they are available on the clock cycle during which the results from the execution unit are generated. The delay pipeline is only required if the latency of the execution unit is greater than one clock. The delay required in the pipeline is one less than the latency of the execution unit.

The architecture of the delay pipeline is shown in FIG. 14. The delay pipeline 1401 contains a number of register stages 1404 that delay the input 1402 relative to the output 1403.

Output Registers Unit

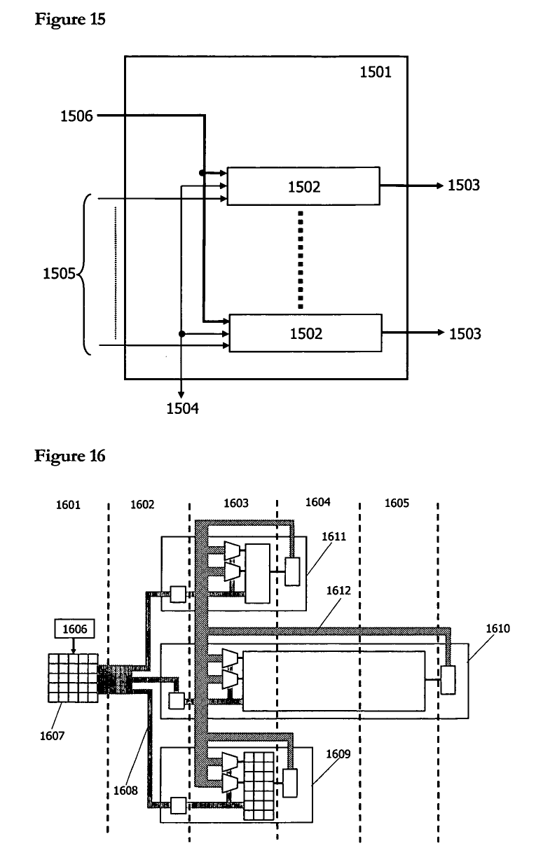

The output registers unit hold results from a particular result port of an execution unit. The architecture is shown in FIG. 15. The output registers unit 1501 may drive a number of connection buses to the operands of other functional units 1503. Each bus has an associated register 1502. The output register mask (that is specified as part of the execution word) 1505 determines which particular registers are updated by an operation executed on the unit. The data 1506 is obtained from the execution unit. An optional test chain 1504 allows the state of the registers to be read and written by a debug system.

Copying Operands

Certain functional units are able to perform a copy operation as a side effect of their normal operation. Copying functionality is required to ensure that all the operands in the processor are fully reachable from all the results. That is, it is possible to move any result to any operand unit via a sequence of copy operations if no direct physical connection is available between the units. The processor architecture is configured so that this is the case.

This copy mechanism has the advantage that it makes use of a side effect of the units operation to perform a copy. Thus very little additional logic is required to support the copying functionality.

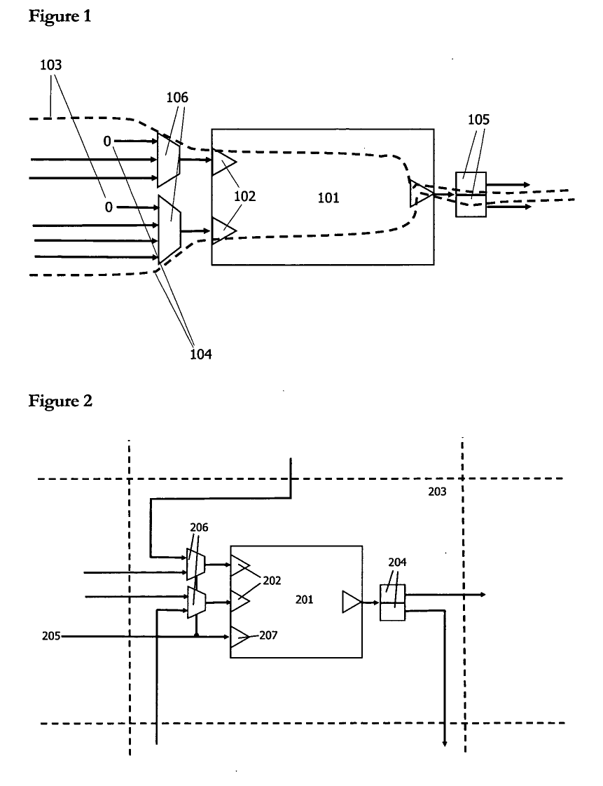

FIG. 1 provides an overview of the copying mechanism. The mechanism relies on the fact that operating with the value 0 is an identity operation for a large number of unit types. The example shows the use of an adder unit 101 for providing a copy but the technique is equally applicable to logical units and various other unit types. Addition of 0 to an operand copies the input operand to the result.

If a copy is to be performed from the upper operand then the lower operand is set to have a value of 0 as shown in 103. This is achieved by fixing the 0 selection for the operand selector to be tied to the literal value 0. The upper operand is added to 0 thus producing a copy of the input value on the output. Conversely if a copy is to be made of the lower operand then the upper operand is set to 0 as shown in 104. The input operands to the unit itself are shown as 102 and the copied results are held in the output registers 105. The operand multiplexers 106 are used to select the appropriate input data.

A special copy method is nominated in the definition of the functional unit that can be used as copies. Such a method must be able to use 0 to perform an identity operation if there are multiple input operands that may be copied.

Pipeline Timing

This section describes the cycle level timing of various activities in the processor pipeline. The architecture is characterized by having a short and highly regular control pipeline but with the flexibility to allow functional units with arbitrary length internal pipelines to be included in the processor. Due to the partitioned nature of the control flow paths in comparison to the data paths, they have separate pipelines.

The control path uses a very simple three stage pipeline reminiscent of early RISC architectures. The three stages are fetch, decode and execute. During the fetch stage the next execution word is read form the instruction cache. During the decode stage the execution word is distributed to the functional units and the appropriate segments are decoded by the units. Finally, during the execute cycle the operations are presented and initiated in the appropriate functional units.

Each of the functional units has its own, independent, pipeline controlled from a master clock. The length of the execution pipeline for each unit is specified in the execution unit model as its latency. The code generator automatically takes account of the length of execution unit pipelines in the management of the data flow between functional units. The independent specification of the pipeline length for each execution unit allows great flexibility in the construction of the individual units. Each functional unit can generate a wait signal. If this is asserted then the entire pipeline of the processor is stalled. This allows the implementation of execution units that sometimes require an extended latency period. For instance, it can be used for cache memory units where the latency is longer if a particular data item is not present in the cache.

The short pipeline allows the branch that occurs at the end of a region to occur without any pipeline bubbles. The last execution of region can occur back-to-back with the first execution cycle of the succeeding one.

Instruction Timing

FIG. 16 provides a timeline of instruction execution in the architecture. During the fetch cycle 1601 the EWA (Execution Word Address) 1606 is used to address the instruction cache 1607 and obtain an execution word. During the decode cycle 1602 the appropriate bits from the word are distributed 1608 to all the functional units in the system. Each of these has comparison logic embedded within the controller glue unit to determine if an operation for that unit has been selected. If so then an operation on functional unit is initiated. All functional units have at least one execute cycle 1603, 1604 and 1605. The data buses 1612 distribute results from functional units to the inputs of other functional units. Each functional unit has a defined latency. The pipelines of the functional units run independently and do not affect the timing of instruction fetching and decoding. The example shows a single cycle functional unit 1611, a multi-cycle functional unit 1610 and a memory unit 1609.

In a typical RISC pipeline all functional unit pipelines must be completed by a write back of results into a centralised register file. Thus the individual functional unit pipelines are intimately tied into the overall control pipeline of the processor as appropriate feed forward paths must be managed to feed data from register writes to subsequent register reads. Since the processor uses software to manage access to register files (they are treated like any other functional unit) the functional unit pipelines can be effectively separated from the overall fetch and decode pipeline. The code scheduling manages the data bus resources and ensures results are only read when they are available from the outputs from functional units.

Data Flow Timing

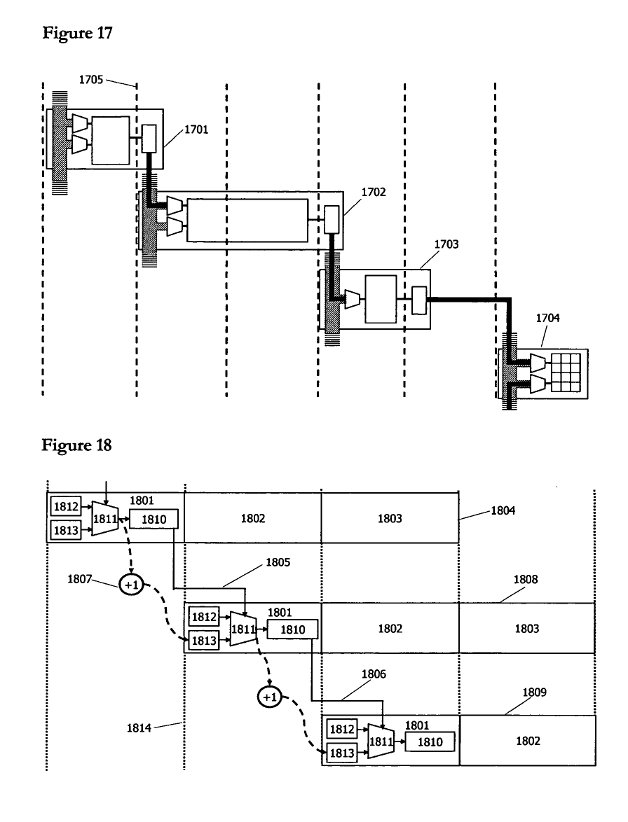

FIG. 17 illustrates the data flow timing of functional units in the preferred embodiment. It shows a particular dynamic data path through the functional units as results are passed from one unit to the next. Each dock cycle boundary is shown as 1705. The initial result is produced from a single cycle functional unit 1701. The result is calculated during cycle 1. It is latched by the output register in the unit at the end of cycle 1 and then driven onto the output bus during cycle 2. At the start of cycle 2 the result is steered into a two-cycle functional unit 1702 operand. It is operated upon during the remainder of that cycle and during cycle 3. At the end of cycle 3 it is latched into the output register and the result driven during cycle 4. It is then steered into another single cycle execution unit 1703. Finally it is held in the output register for an extra cycle while other operands for a subsequent operation become available. During cycle 6 the data item is written into a memory unit 1704.

Region Succession Mechanism

The control mechanism for performing a region succession is illustrated in FIG. 18. Such a succession occurs when the end of a region is reached.

The destination address is determined prior to the end of the region and put into register 1812. A sufficient number of clock cycles are left between the resolution of the last potential branch in the region and the last execution word in the region (in which the ERF flag is set). This will leave a new instruction address available that has been looked up from the instruction cache.

The mechanism allows a flag to be set on the last instruction of a region (ERF) and to immediately initiate a succession so that the first instruction from the new region can be executed without any further latency.

The instruction 1804 is the last to be executed in a region. Thus it has the End Region Flag (ERF) set 1805 which is used to control a multiplexer 1811 that selects the next execution address from either the Execution Word Address (EWA) 1813 or the new address 1812. The next execution address is applied to the instruction cache 1810. This selection can be performed during the same cycle as the access itself, thus allowing very quick address steering. The EWA is incremented 1807 by one on each cycle 1814 so that execution is advanced through the region. Thus the first instruction 1808 of the new region is executed as EWA is loaded with the new address plus one. The ERF for the first instruction of the new region is reset 1806, causing the selection of the EWA pointing to the second instruction of the region. Thus instruction 1809 is the second to be executed from the new region.

Each instruction consists of a fetch cycle 1801, a decode cycle 1802 and an execute cycle 1803.

Branch Control Unit

Branches operations may be issued to the branch unit. Branch operations only load the required destination information into the branch registers within the branch control unit. The actual branch is not performed until the end of the region is reached. Thus a multi-way branch is resolved at the end of the region execution.

The branch control unit determines which region will be executed next. The unit is able to handle multi-way branch conditions. A number of branch destinations with associated conditions may be issued in a region. The branch control unit determines which branch will be taken on the basis of which conditions evaluate to true and the relative priority of the branches.

Region Branch State (RBS)

The RBS is a register that holds the current state for a destination branch selected from a region. The RBS has three possible states as listed below:

Default: This is the default state that indicates that there should be a fall through to the following region when the execution of the current one is completed.

Restart: This indicates that the current region should be re-executed when the current execution is completed. The region address is obtained from the Region Base Address register.

Branch: Indicates that the branch control unit has selected a branch destination. Branches are given a static priority which may differ from their issue order. The branch issued with the highest priority and a true condition is selected.

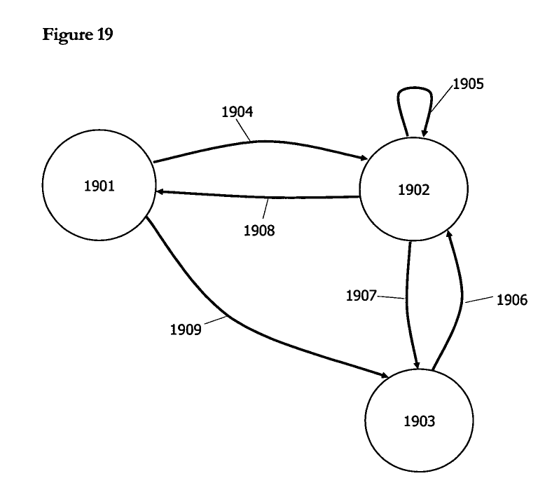

The state transitions are detailed in FIG. 19. The initial state is Default 1901. The other possible states are Branch 1902 and Restart 1903. If a branch is selected 1904 then a transition is made from the Default to the Branch state. A return to the Default state is made if the end of the region is reached. Earlier branches may be selected 1905 while in Branch mode without changing the state. In some circumstances a data hazard may require a re-execution of a region. The transition 1909 is then made from Default state to Restart state to arrange for the region to be re-executed to resolve the hazard. If in Branch state and a region execution needs to be repeated due to a data hazard then a transition 1907 is made to the Restart state. Finally, if in Restart state and a branch earlier than the cause of a restart performs a branch then the transition is made to the Branch state.

Region Base Address (RBA)

The RBA register holds the address of the start of the region currently being executed. It is loaded with the value of Next Region Address (NRA) at the start of each new region execution. It is used to generate the next value of NRA if a region is to be restarted.

Next Region Address (NRA)

The NRA register contains the address of the next region that is to be executed. The branch resolution unit calculates the NRA as each branch is issued. The highest priority branch s selected as the destination. The branch does not occur until the end of the current region is reached. The NRA consists of two fields. There is a full destination address that allows the specification of an address in main memory.

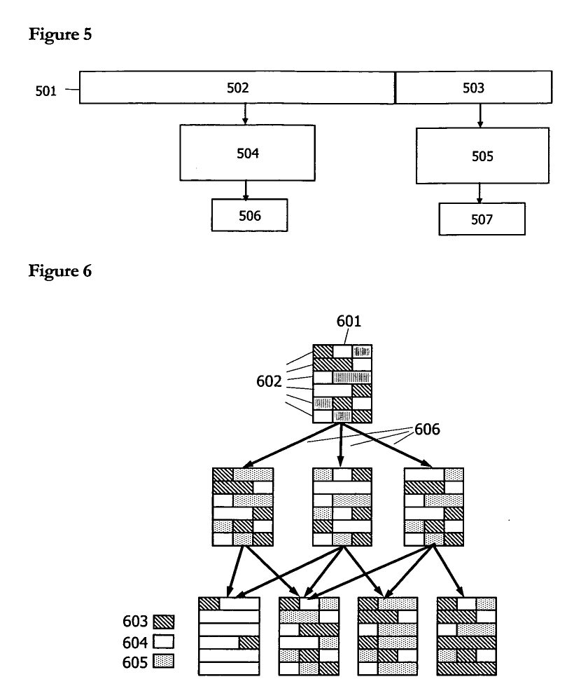

The use of the NRA is illustrated in FIG. 5. When the end of the region is reached the NRA register 501 is used to find the correct entry in the instruction cache and to set the initial predicate status bits. The address of the region within the instruction cache 502 is looked up 504 in the instruction cache and is then loaded into EWA, from where execution of the region is commenced. The lowest predicate to be set 503 is converted into a mask 505 showing which predicates are valid and then loaded into a predicate mask register 507.

Branch Resolution Architecture

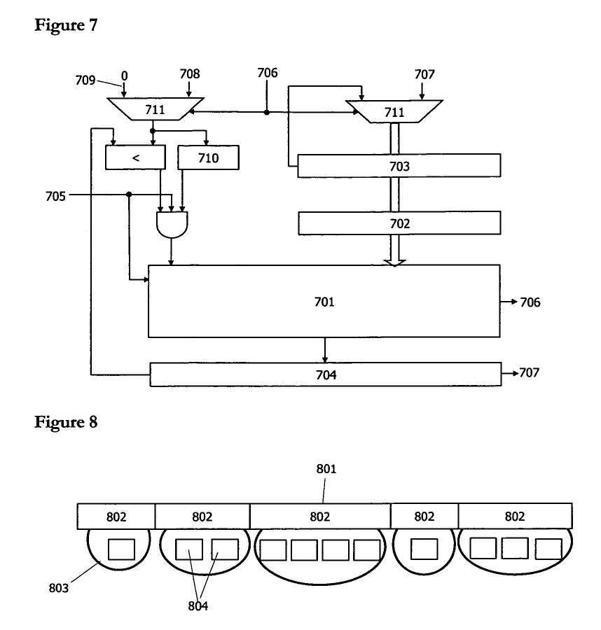

This unit is responsible for selecting a destination address. The structure of the branch resolution unit is shown in FIG. 7. A branch destination address is supplied 707 by the branch functional unit. A multiplexer 711 selects between that address and the RBA 703 on the basis of the loop flag 706 supplied from the branch functional unit. This allows a branch to be issued that causes a branch to the start of the region without having to specify a destination address.

A Next Execution Address (NEA) 702 is used to hold the address of a following region to be executed in the absence of a branch being issued in a region.

A branch priority and predicate condition 708 is supplied from the branch functional unit. Multiplexer 711 selects the default state 709 if a loop is being performed. This is compared against the previously highest priority from the current Next Region Address (NRA) 704. If a branch priority is higher than a previously selected branch then it is used instead. A demultiplexer 710 is used to determine if the branch predicate 705 is true. The block 701 is responsible for maintaining the RBS state machine and selecting destinations as required. It supplies a squash vector 706 to a predicate control unit.

At the end of a region execution the NRA 704 holds the destination address that is supplied to the instruction cache via 707.

It is understood that there are many possible alternative embodiments of the invention. It is recognized that the description contained herein is only one possible embodiment. This should not be taken as a limitation of the scope of the invention. The scope should be defined by the claims and we therefore assert as our invention all that comes within the scope and spirit of those claims.

1. A microprocessor with an architecture incorporating several execution units, whereby:
(a) one or more registers store results from particular execution units;
(b) execution unit operands receive data from one such register;
(c) certain execution units are able to copy data from their operands to result registers; and
(d) the copy capability is used to allow execution units that are not directly connected to communicate data.

2. The microprocessor according to claim 1 whereby one or more of the execution units may be register files.

3. The microprocessor according to claim 1 whereby the set of registers associated with a particular execution unit to be written may be specified for each operation.

4. The microprocessor according to claim 3 whereby the specification of registers to write is represented in an instruction format.

5. The microprocessor according to claim 4 whereby the specification of registers to write is delayed in a pipeline so as to be available on the same clock cycle as the results.

6. The microprocessor according to claim 1 whereby the connectivity between execution units is known to code generation software tools.

7. The microprocessor according to claim 1 whereby available execution units are specified in a library file.

8. The microprocessor according to claim 7 whereby the connectivity of execution units to other units in the system is configurable.

9. The microprocessor according to claim 8 whereby the number of output registers associated with an execution unit is configurable.

10. The microprocessor according to claim 1 whereby the update of the result registers is dependent on global condition state for certain execution units.

11. The microprocessor according to claim 10 whereby the state used to control the output register update is selectable as part of the instruction set.

12. The microprocessor according to claim 1 whereby certain identity operations may be issued to an execution unit in order to perform a copy.

13. The microprocessor according to claim 1 whereby the operation of certain bits with an execution word control certain execution units on a cycle by cycle basis.

14. The microprocessor according to claim 13 whereby the number of bits required to control each execution unit varies depending upon the extent of its connectivity.

15. The microprocessor according to claim 13 whereby certain bits within the execution word for each execution unit select different types of operation to be performed.

16. The microprocessor according to claim 1 whereby each result register may be connected to one or more execution unit operands.

17. The microprocessor according to claim 1 whereby a source register for a particular execution unit operand may be specified by the instruction set.

18. The microprocessor according to claim 1 whereby the processor executes a sequence of contiguous execution words.

19. The microprocessor according to claim 18 whereby, when the end the execution word sequence is reached, execution may branch to one of a number of different execution word addresses.

20. The microprocessor according to claim 19 whereby the same execution word sequence may be repeated to resolve a data hazard.

21. The microprocessor according to claim 20 whereby there is a branch control unit for determining the destination of such branches.

22. The microprocessor according to claim 21 whereby the branch control unit may accept branches out of their sequential order.

23. The microprocessor according to claim 22 whereby the branch control unit may disable the operation of certain subsequent operations depending on the sequential position of an accepted branch.

24. A method of operation used in a microprocessor with an architecture incorporating several execution units, whereby:
(a) one or more registers store results from particular execution units;
(b) execution unit operands receive data from one such register; and
(c) certain execution units are able to copy data from their operands to result registers; and
(d) the copy capability is used to allow execution units that are not directly connected to communicate data.

25. (canceled)
